(19) United States
(12) Patent Application Publication
(10) Pub. No.: US 2019/0315132 A1
(43) Pub. Date: Oct. 17, 2019

(54) INKJET PRINTER

(71) Applicant: Roland DG Corporation, Hamamatsu-shi (JP)

(72) Inventor: Harumichi DOO, Hamamatsu-shi (JP)

(21) Appl. No.: 16/382,272

(22) Filed: Apr. 12, 2019

(30) Foreign Application Priority Data
Apr. 16, 2018 (JP) 2018-078189

(51) Int. Cl. B41J 11/00; B41J 25/00

(52) U.S. Cl. CPC B41J 11/002; B41J 25/001

(57) ABSTRACT

A printer includes ink heads and an ultraviolet light emitter. The ink heads discharge ultraviolet-curable ink onto a recording medium on a platen. The ultraviolet light emitter is disposed leftward of the ink heads in a main scanning direction. The ultraviolet light emitter emits ultraviolet light to the ultraviolet-curable ink discharged onto the recording medium. The ultraviolet light emitter includes a case, LEDs, and a glass block. The case includes an opening in a portion of the case facing the platen. The LEDs are disposed in the case and emit ultraviolet light toward the recording medium on the table through the opening. The glass block guides the ultraviolet light, emitted from the LEDs, to the opening. A center of the LEDs in the main scanning direction is closer to the ink heads than a center of the glass block in the main scanning direction.

### CROSS REFERENCE TO RELATED APPLICATIONS

This application claims the benefit of priority to Japanese Patent Application No. 2018-078189 filed on Apr. 16, 2018. The entire contents of this application are hereby incorporated herein by reference.

### BACKGROUND OF THE INVENTION

### 1. Field of the Invention

The present invention relates to inkjet printers.

### 2. Description of the Related Art

An inkjet printer that uses ultraviolet-curable ink is known in the related art. Such an inkjet printer may hereinafter be simply referred to as an “ultraviolet-curing printer”. An ultraviolet-curing printer includes, for example, a table, an ink head, and an ultraviolet light emitter. A recording medium is placed on the table. The ink head includes a nozzle to discharge ultraviolet-curable ink onto the recording medium placed on the table. The ultraviolet light emitter emits ultraviolet light to the ultraviolet-curable ink discharged onto the recording medium. The ultraviolet light emitter emits ultraviolet light to the ultraviolet-curable ink on the recording medium so as to cure the ultraviolet-curable ink and define ink layer(s) on the recording medium. The ultraviolet-curing printer is thus able to print a desired image. JP 2016-221852 A, for example, discloses an example of an ultraviolet light emitter used in an ultraviolet-curing printer.

In order to reliably cure ultraviolet-curable ink discharged onto a recording medium, ultraviolet light is emitted from an ultraviolet light emitter to a region larger than an ink region where the ultraviolet-curable ink discharged is present. A portion of the ultraviolet light emitted is thus reflected off the recording medium and/or table. The ultraviolet light reflected off the recording medium and/or table may reach a nozzle of an ink head. If ultraviolet-curable ink is attached to the nozzle and a portion of the ink head adjacent to the nozzle, the ultraviolet light may be emitted to the ultraviolet-curable ink attached. This may unfortunately cure the ultraviolet-curable ink attached to the nozzle and the portion of the ink head adjacent to the nozzle. Curing the ultraviolet-curable ink attached to, for example, the nozzle results in defective discharge of ultraviolet-curable ink from the nozzle.

### SUMMARY OF THE INVENTION

Accordingly, preferred embodiments of the present invention provide inkjet printers that are able to reduce the amount of ultraviolet light reflected toward nozzles of ink heads.

An inkjet printer according to a preferred embodiment of the present invention includes a table, a carriage, an ink head, and an ultraviolet light emitter. A recording medium is placed on the table. The carriage is disposed above the table. The carriage is movable in a main scanning direction. The ink head is mounted on the carriage. The ink head includes a nozzle to discharge ultraviolet-curable ink onto the recording medium placed on the table. The ultraviolet light emitter is mounted on the carriage. The ultraviolet light emitter is disposed on one side relative to the ink head in the main scanning direction. The ultraviolet light emitter emits ultraviolet light to the ultraviolet-curable ink discharged onto the recording medium. The ultraviolet light emitter includes a case, a light source, and a first light guide. The case includes an opening in a portion of the case that faces the table. The light source is disposed in the case. The light source emits ultraviolet light toward the recording medium on the table through the opening. The first light guide is disposed below the light source and above the opening. The first light guide guides the ultraviolet light, emitted from the light source, to the opening. A center of the light source in the main scanning direction is located closer to the ink head than a center of the first light guide in the main scanning direction.

The inkjet printer according to the preferred embodiment of the present invention includes the light source to emit ultraviolet light, and the first light guide. The center of the light source in the main scanning direction is located closer to the ink head than the center of the first light guide in the main scanning direction. The light source emits ultraviolet light in various directions. The ultraviolet light emitted toward the recording medium and/or the table through the opening includes ultraviolet light emitted toward the ink head. The ultraviolet light emitted toward the ink head, however, is reflected by the first light guide before reaching the opening. The ultraviolet light emitted toward the ink head is thus prevented from being directed to the ink head. Consequently, the inkjet printer according to the present preferred embodiment is able to reduce the amount of ultraviolet light reflected off the recording medium and/or the table and directed to the ink head, while appropriately emitting ultraviolet light to the ultraviolet-curable ink discharged onto the recording medium.

The first light guide may include a cuboid structure that allows the ultraviolet light emitted from the light source to be refracted and extend through the cuboid structure. The first light guide may be made of quartz glass or a resin material. The first light guide may be an absorber to absorb the ultraviolet light emitted from the light source. The first light guide may be a metallic material or a mirror that reflects the ultraviolet light emitted from the light source. The inkjet printer may include a combination of two or more light guides such as those described above. When the inkjet printer includes a combination of two light guides such as those described above, one of the light guides (e.g., the mirror) may be disposed around the other light guide (e.g., the cuboid member).

Various preferred embodiments of the present invention provide inkjet printers that are able to reduce the amount of ultraviolet light reflected toward nozzles of ink heads.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front view of a printer according to a first preferred embodiment of the present invention.

FIG. 2 is a perspective view of an ink head unit according to the first preferred embodiment of the present invention.

FIG. 3 is a front view of the ink head unit according to the first preferred embodiment of the present invention.

FIG. 4 is a bottom view of the ink head unit according to the first preferred embodiment of the present invention.

FIG. 5 is a block diagram of the printer according to the first preferred embodiment of the present invention.

FIG. 6 is a cross-sectional view of an ultraviolet light emitter according to the first preferred embodiment of the present invention.

FIG. 7 is a side view of the ultraviolet light emitter according to the first preferred embodiment of the present invention.

FIG. 8 is a cross-sectional view of an ultraviolet light emitter according to a second preferred embodiment of the present invention.

FIG. 9 is a cross-sectional view of an ultraviolet light emitter according to a third preferred embodiment of the present invention.

### DETAILED DESCRIPTION OF THE PREFERRED EMBODIMENTS

Inkjet printers (hereinafter each referred to as a “printer”) according to preferred embodiments of the present invention will be described below with reference to the drawings. The preferred embodiments described below are naturally not intended to limit the present invention in any way. Components or elements having the same functions are identified by the same reference signs, and description thereof will be simplified or omitted when deemed redundant.

### First Preferred Embodiment

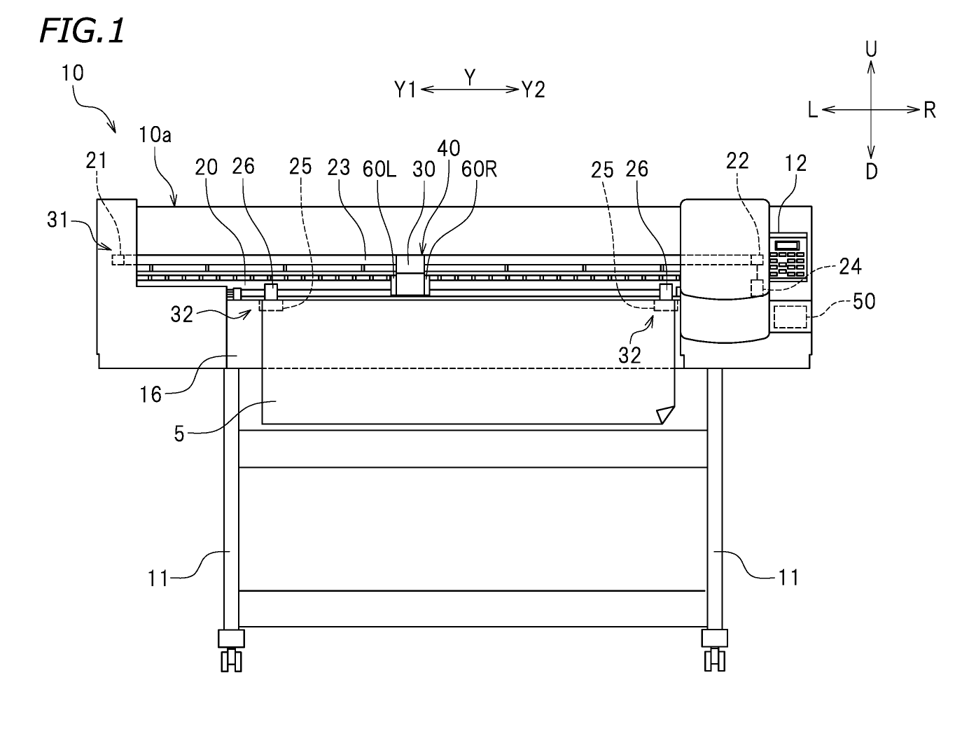

FIG. 1 is a front view of a printer 10 according to a first preferred embodiment of the present invention. As used herein, the term “forward” refers to a direction away from the rear of the printer 10 and toward a user facing the front of the printer 10, and the term “rearward” refers to a direction away from the user facing the front of the printer 10 and toward the rear of the printer 10. The terms “right”, “left”, “up”, and “down” respectively refer to right, left, up, and down with respect to the user facing the front of the printer 10. The reference signs F, Rr, R, L, U, and D in the drawings respectively represent front, rear, right, left, up, and down. The reference sign Y in the drawings represents a main scanning direction. In the present preferred embodiment, the main scanning direction Y is a right-left direction. The reference sign X in the drawings represents a sub-scanning direction. In the present preferred embodiment, the sub-scanning direction X is a front-rear direction. The sub-scanning direction X is perpendicular or substantially perpendicular to the main scanning direction Y in a plan view. In the present preferred embodiment, a direction from the right side of the printer 10 to the left side of the printer 10 will be referred to as an “onward direction Y1”, and a direction from the left side of the printer 10 to the right side of the printer 10 will be referred to as a “backward direction Y2”. These directions are defined merely for the sake of convenience of description and do not limit in any way how the printer 10 may be installed or how the present invention may be practiced.

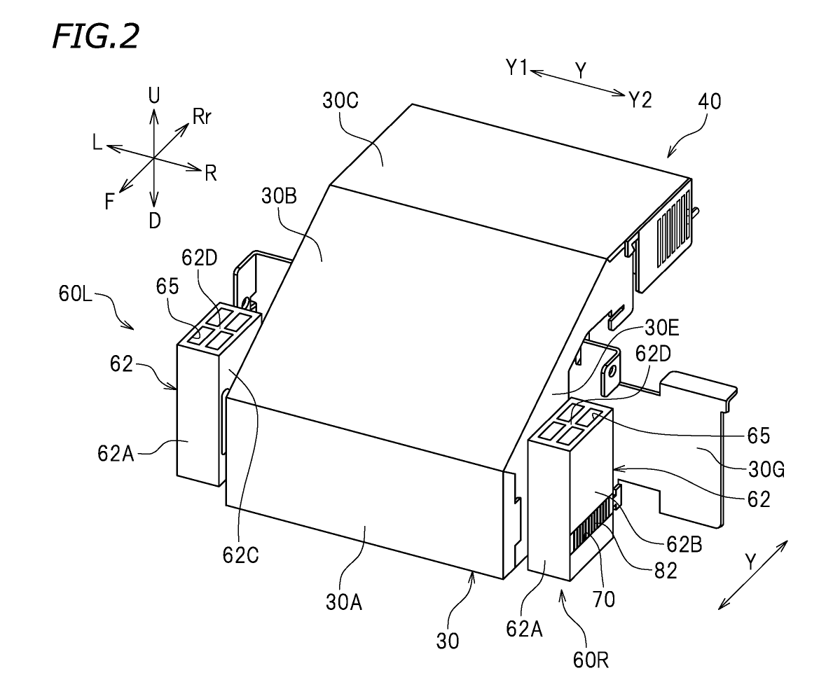

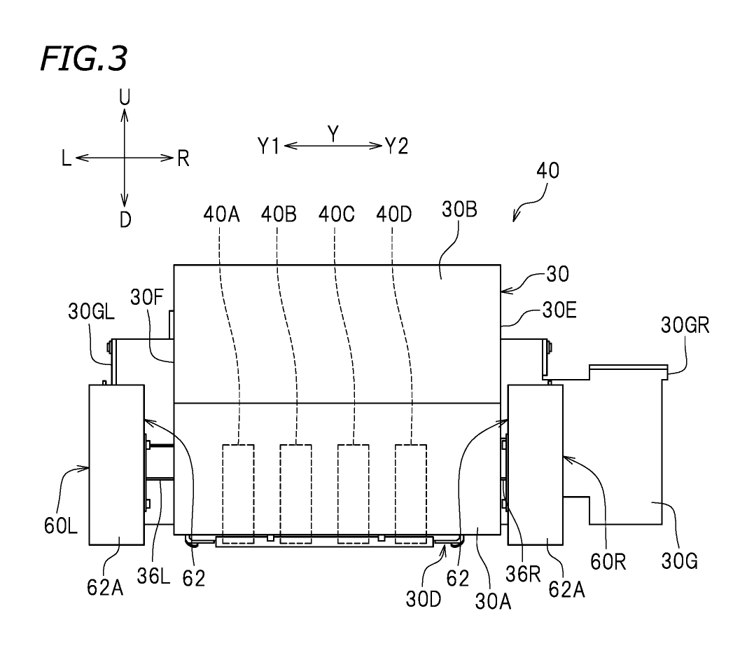

The printer 10 is an inkjet printer. The printer 10 is a “large printer” that is longer in the main scanning direction Y than printers for home use. In one example, the printer 10 is a business-use printer. In the present preferred embodiment, the printer 10 includes a carriage 30 (see also FIG. 2) that moves in the main scanning direction Y, and ink heads 40A, 40B, 40C, and 40D (see FIG. 3) mounted on the carriage 30. A recording medium 5 in a roll form is placed in the printer 10. The printer 10 sequentially moves an unrolled portion of the recording medium 5 forward and causes the ink heads 40A to 40D to discharge ultraviolet-curable ink onto the unrolled portion of the recording medium 5. The printer 10 thus prints an image on the recording medium 5.

Ultraviolet-curable ink has the property of being cured by ultraviolet light emitted thereto. Examples of such ultraviolet-curable ink include image-forming ink, primer, and clear ink. The image-forming ink is used to form an image to be printed on the recording medium 5. The image-forming ink contains a coloring agent (such as a pigment), a photopolymerization monomer, and a photopolymerization initiator system. When necessary, the image-forming ink contains various other additives. Examples of the additives may include a photosensitizer, a polymerization inhibitor, a scavenger, an antioxidant, an ultraviolet light absorber, a plasticizer, a surfactant, a leveling agent, a thickener, a disperser, an antifoaming agent, an antiseptic, and a solvent. The image-forming ink is colored ink. The image-forming ink is process color ink or white ink, for example. Examples of the process color ink include cyan ink, magenta ink, yellow ink, black ink, light cyan ink, and light magenta ink. The primer is used to increase fixability of the image-forming ink to the recording medium 5. The primer contains no coloring agent (such as a pigment). The primer contains a photopolymerization monomer, a photopolymerization initiator system, and a binding agent (e.g., binder resin). When necessary, the primer may contain various other additives similar to those for the image-forming ink. The color of the primer may be transparent, white, or gray, for example. The clear ink is discharged onto a surface of the image-forming ink and thus defines and functions as an overcoat layer covering the image-forming ink. The clear ink contains no coloring agent (such as a pigment). The clear ink contains a photopolymerization monomer and a photopolymerization initiator system. When necessary, the clear ink may contain various other additives similar to those for the image-forming ink.

A material for the recording medium 5 is not limited to any particular type of material. The recording medium 5 may be a permeable sheet or film that is permeable to the ultraviolet-curable ink or may be a non-permeable sheet or film that is non-permeable to the ultraviolet-curable ink. In one example, the recording medium 5 may be a coated sheet or coated film provided by applying a material, such as resin, to a surface of a base material permeable to the ultraviolet-curable ink.

Examples of the permeable sheet or film include paper, such as plain paper and inkjet printable paper. Examples of the non-permeable sheet or film include: a sheet or film made of resin, such as polyester resin (e.g., polyethylene terephthalate (PET) resin, or polyethylene naphthalate (PEN) resin), polyolefin resin (e.g., polyethylene (PE) resin, polypropylene (PP) resin, or ethylene-propylene copolymer), polyether resin (e.g., polyurethane resin), polycarbonate (PC) resin, polyimide resin, polyamide resin, fluororesin, or acrylic resin (e.g., polymethyl methacrylate (PMMA) resin); a sheet or film made of metal, such as stainless steel, aluminum, iron, or copper; a sheet or film made of glass; a sheet or film made of rubber; and a composite sheet or film provided by a combination of two or more of these materials. Examples of the coated sheet or coated film include enamel paper, art paper, coated paper, cast-coated paper, mat paper, and glossy paper.

As illustrated in FIG. 1, the printer 10 includes a printer body 10a, legs 11, an operation panel 12, a platen 16, an ink head unit 40, a head conveyor 31, a medium conveyor 32, and a controller 50. The printer body 10a includes a casing extending in the main scanning direction Y. The legs 11 support the printer body 10a. The legs 11 are provided on the lower surface of the printer body 10a. In one example, the operation panel 12 is provided on the front surface of the right portion of the printer body 10a. Alternatively, the operation panel 12 may be provided at any other suitable location. The user, for example, performs printing-related operations through the operation panel 12.

The platen 16 supports the recording medium 5 when printing is performed on the recording medium 5. The platen 16 is an example of a table. The recording medium 5 is placed on the platen 16. Printing is performed on the recording medium 5 on the platen 16. The platen 16 is provided in the printer body 10a. The platen 16 extends in the main scanning direction Y.

The head conveyor 31 moves the carriage 30 of the ink head unit 40 relative to the recording medium 5, placed on the platen 16, in the main scanning direction Y. The head conveyor 31 moves the carriage 30 in the main scanning direction Y. The head conveyor 31 is not limited to any particular configuration or structure. The head conveyor 31 includes a guide rail 20, a left pulley 21, a right pulley 22, an endless belt 23, and a carriage motor 24. The guide rail 20 guides movement of the carriage 30 in the main scanning direction Y. The guide rail 20 is provided in the printer body 10a. The guide rail 20 is disposed above the platen 16. The guide rail 20 extends in the main scanning direction Y. The left pulley 21 is provided leftward of the left end of the guide rail 20. The right pulley 22 is provided rightward of the right end of the guide rail 20. The belt 23 is wound around the left pulley 21 and the right pulley 22. The right pulley 22 is connected with the carriage motor 24. Alternatively, the carriage motor 24 may be connected to the left pulley 21. In the present preferred embodiment, driving the carriage motor 24 rotates the right pulley 22 so as to cause the belt 23 to run between the pulleys 21 and 22.

As illustrated in FIG. 1, the ink head unit 40 is provided in the printer body 10a. The ink head unit 40 is disposed above the platen 16. The ink head unit 40 includes the carriage 30, the ink heads 40A to 40D (see FIG. 3), a left ultraviolet light emitter 60L, and a right ultraviolet light emitter 60R.

The carriage 30 is attached to the belt 23. The carriage 30 is in engagement with the guide rail 20 such that the carriage is slidable along the guide rail 20. The carriage 30 is disposed above the platen 16. The ink heads 40A to 40D (see FIG. 3) are mounted on the carriage 30. Driving the carriage motor 24 causes the belt 23 to run so as to move the carriage 30 in the main scanning direction Y. In accordance with the movement of the carriage 30 in the main scanning direction Y, the ink heads 40A to 40D mounted on the carriage 30 move in the main scanning direction Y.

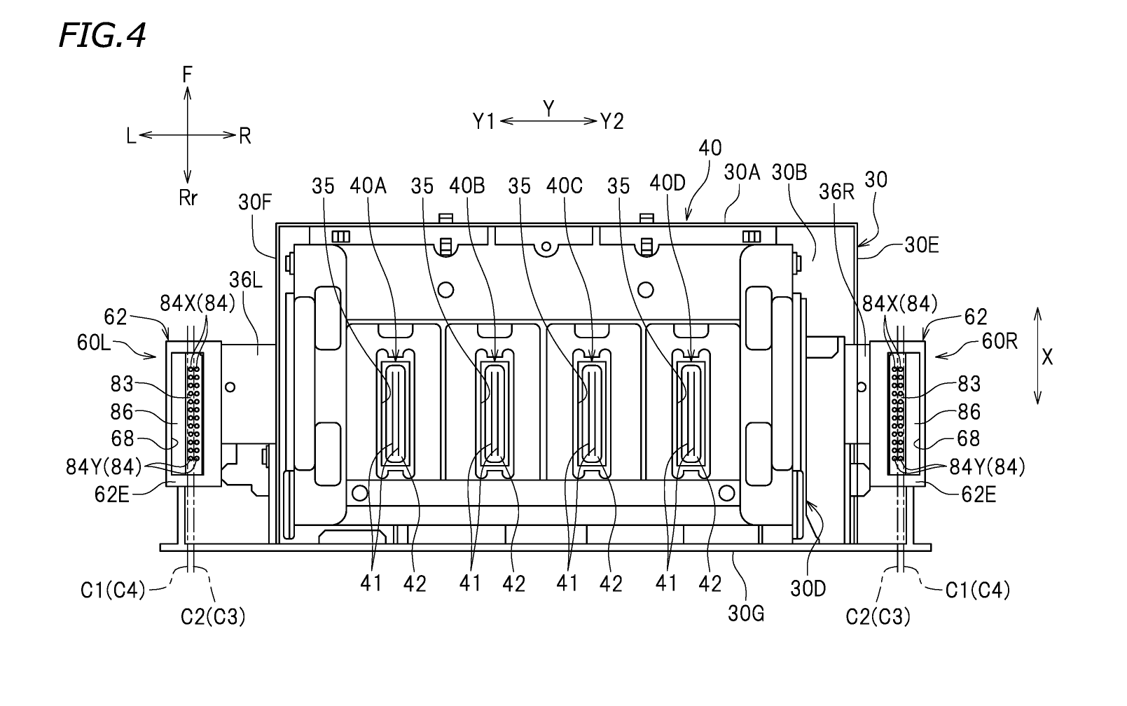

As illustrated in FIG. 2, the carriage 30 includes a front wall 30A, an inclined wall 30B, an upper wall 30C, a bottom wall 30D (see FIG. 4), a right side wall 30E, a left side wall 30F (see FIG. 3), and a rear wall 30G. The front wall 30A extends in the right-left direction and up-down direction. The inclined wall 30B extends obliquely upward and rearward from the upper end of the front wall 30A. The upper wall 30C extends rearward from the upper end of the inclined wall 30B. As illustrated in FIG. 4, the bottom wall 30D is disposed under the inclined wall 30B. The bottom wall 30D is provided with openings 35. The ink heads 40A to 40D are each fitted into an associated one of the openings 35. As illustrated in FIG. 2, the right side wall 30E is connected to the right end of the front wall 30A, the right end of the inclined wall 30B, and the right end of the upper wall 30C. The left side wall 30F is connected to the left end of the front wall 30A, the left end of the inclined wall 30B, and the left end of the upper wall 30C. The rear wall 30G is disposed below the inclined wall 30B. The rear wall 30G extends in the main scanning direction Y. As illustrated in FIG. 3, the rear wall 30G includes a right end 30GR located rightward of the right side wall 30E. The rear wall 30G includes a left end 30GL located leftward of the left side wall 30F. The rear wall 30G is connected to the bottom wall 30D but is a component separate from the inclined wall 30B.

As illustrated in FIG. 4, the ink heads 40A to 40D are arranged in the main scanning direction Y. The length of each of the ink heads 40A to 40D in the front-rear direction is longer than the length of each of the ink heads 40A to 40D in the right-left direction. The ink heads 40A to 40D are identical in shape and size. The ink heads 40A to 40D each include a plurality of nozzles 41 arranged in the sub-scanning direction X, and a nozzle surface 42 provided with the nozzles 41. The nozzles 41 discharge the ultraviolet-curable ink onto the recording medium 5 placed on the platen 16. Because the nozzles 41 are very small, the nozzles 41 are indicated by straight lines in FIG. 4. In the present preferred embodiment, the ink heads 40A to 40D each include the nozzles 41 arranged in two rows. Alternatively, the ink heads 40A to 40D may each include the nozzles 41 arranged in a row or the nozzles 41 arranged in three or more rows. The ink heads 40A to 40D are movable along the guide rail 20 in the main scanning direction Y together with the carriage 30.

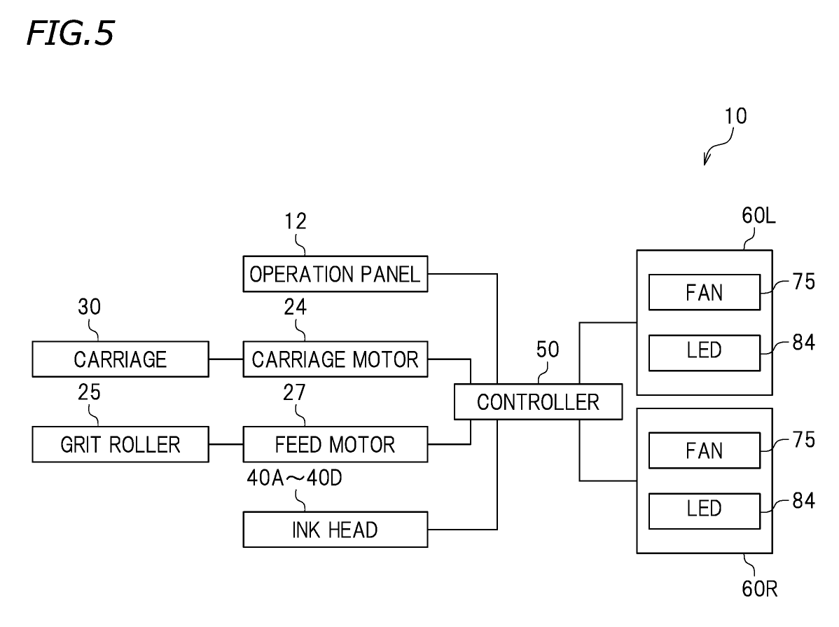

The medium conveyor 32 moves the recording medium 5, placed on the platen 16, relative to the carriage 30 in the sub-scanning direction X. In the present preferred embodiment, the medium conveyor 32 moves the recording medium 5, placed on the platen 16, in the sub-scanning direction X (see FIG. 2). The medium conveyor 32 is not limited to any particular configuration or structure. As illustrated in FIG. 1, the medium conveyor 32 includes grit rollers 25, pinch rollers 26, and a feed motor 27 (see FIG. 5). The grit rollers 25 are provided on the platen 16. In the present preferred embodiment, the grit rollers 25 are embedded in the platen 16 such that the upper portions of the grit rollers 25 are exposed to outside. The pinch rollers 26 press the recording medium 5 from above. Each of the pinch rollers 26 is disposed over an associated one of the grit rollers 25 such that each pinch roller 26 faces the associated grit roller 25 in the up-down direction. The pinch rollers 26 may be movable in the up-down direction in accordance with the thickness of the recording medium 5. The position of each grit roller 25 is not limited to any particular position. The number of grit rollers 25 is not limited to any particular number. The position of each pinch roller 26 is not limited to any particular position. The number of pinch rollers 26 is not limited to any particular number. In the present preferred embodiment, one of the grit rollers 25 and one of the pinch rollers 26 are disposed adjacent to the left end of the platen 16, and the other one of the grit rollers 25 and the other one of the pinch rollers 26 are disposed adjacent to the right end of the platen 16. The feed motor 27 is connected to the grit rollers 25. With the recording medium 5 sandwiched between each grit roller 25 and the associated pinch roller 26, the feed motor 27 is driven so as to rotate the grit rollers 25. This conveys the recording medium 5 in the sub-scanning direction X.

The left ultraviolet light emitter 60L and the right ultraviolet light emitter 60R emit ultraviolet light to the ultraviolet-curable ink discharged onto the recording medium 5. As illustrated in FIG. 3, the left ultraviolet light emitter 60L is disposed leftward of the ink head 40A. The right ultraviolet light emitter 60R is disposed rightward of the ink head 40D. The left ultraviolet light emitter 60L and the right ultraviolet light emitter 60R are mounted on the carriage 30. More specifically, the left ultraviolet light emitter 60L is attached to a left stay 36L provided on the left side wall 30F and the rear wall 30G of the carriage 30. The right ultraviolet light emitter 60R is attached to a right stay 36R provided on the right side wall 30E and the rear wall 30G of the carriage 30. The left ultraviolet light emitter 60L and the right ultraviolet light emitter 60R are disposed symmetrically with respect to an axis of symmetry perpendicular to the main scanning direction Y. The left ultraviolet light emitter 60L and the right ultraviolet light emitter 60R are movable along the guide rail 20 in the main scanning direction Y together with the carriage 30.

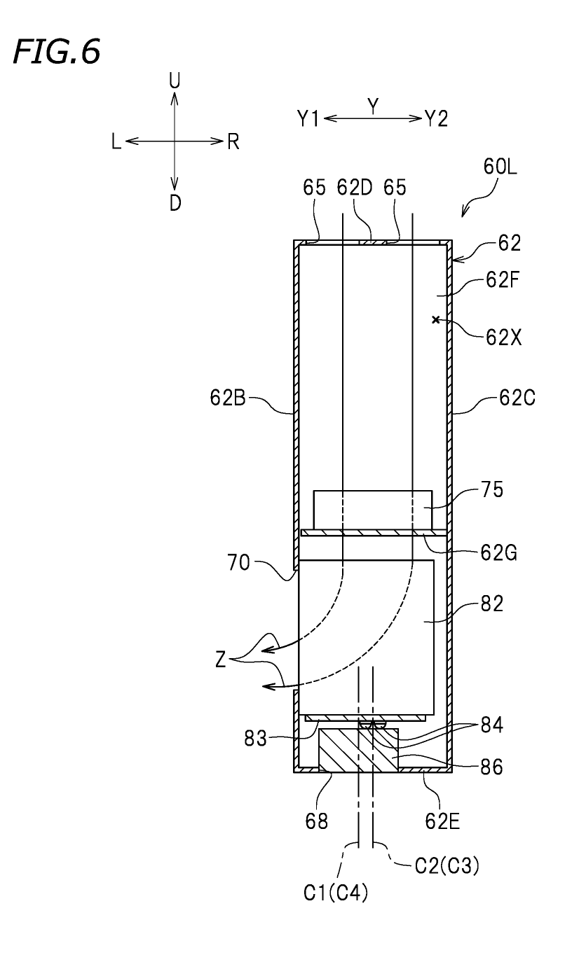

The left ultraviolet light emitter 60L and the right ultraviolet light emitter 60R will be described below in more detail. The left ultraviolet light emitter 60L and the right ultraviolet light emitter 60R are similar in configuration except that the left ultraviolet light emitter 60L and the right ultraviolet light emitter 60R are symmetric with respect to the axis of symmetry perpendicular to the main scanning direction Y. The following description thus discusses the left ultraviolet light emitter 60L and omits the features and functions of the right ultraviolet light emitter 60R similar to those of the left ultraviolet light emitter 60L. As illustrated in FIG. 6, the left ultraviolet light emitter 60L includes a case 62, fans 75, a heat sink 82, light-emitting diodes (LEDs) 84, and a glass block 86.

As illustrated in FIG. 6, the case 62 has a cuboid shape. The case 62 includes an inner space 62X. Air flows into and out of the inner space 62X through a plurality of inlets 65 and an outlet 70 (which will be described below). The case 62 includes a front wall 62A (see FIG. 2), a first side wall 62B, a second side wall 62C, an upper wall 62D, a lower wall 62E, and a rear wall 62F.

The front wall 62A (see FIG. 2) extends in the up-down direction and right-left direction. The first side wall 62B extends rearward from the left end of the front wall 62A. The second side wall 62C extends rearward from the right end of the front wall 62A. The second side wall 62C is disposed to face the first side wall 62B. The upper wall 62D extends rearward from the upper end of the front wall 62A. The lower wall 62E extends rearward from the lower end of the front wall 62A. The lower wall 62E is disposed to face the upper wall 62D. The lower wall 62E is disposed to face the platen 16. The rear wall 62F is connected to the rear end of the first side wall 62B, the rear end of the second side wall 62C, the rear end of the upper wall 62D, and the rear end of the lower wall 62E. The rear wall 62F is disposed to face the front wall 62A. As illustrated in FIG. 3, the second side wall 62C (see FIG. 2) of the left ultraviolet light emitter 60L is secured to the left stay 36L. The second side wall 62C of the right ultraviolet light emitter 60R is secured to the right stay 36R.

As illustrated in FIG. 6, the case 62 includes the inlets 65 defined in the upper wall 62D. The inlets 65 extend through the upper wall 62D in the up-down direction. The inlets 65 are in communication with the inner space 62X. Outside air is introduced into the inner space 62X through the inlets 65. As illustrated in FIG. 2, the inlets 65 each have a rectangular shape, for example.

As illustrated in FIG. 6, the case 62 includes the outlet 70 defined in the first side wall 62B. The outlet 70 extends through the first side wall 62B in the right-left direction. The outlet 70 is in communication with the inner space 62X. Air blown from the fans 75 extends through the heat sink 82 and is then discharged out of the case 62 through the outlet 70. In other words, the outside air introduced into the inner space 62X through the inlets 65 is discharged out of the case 62 through the outlet 70. The outlet 70 is defined below the inlets 65.

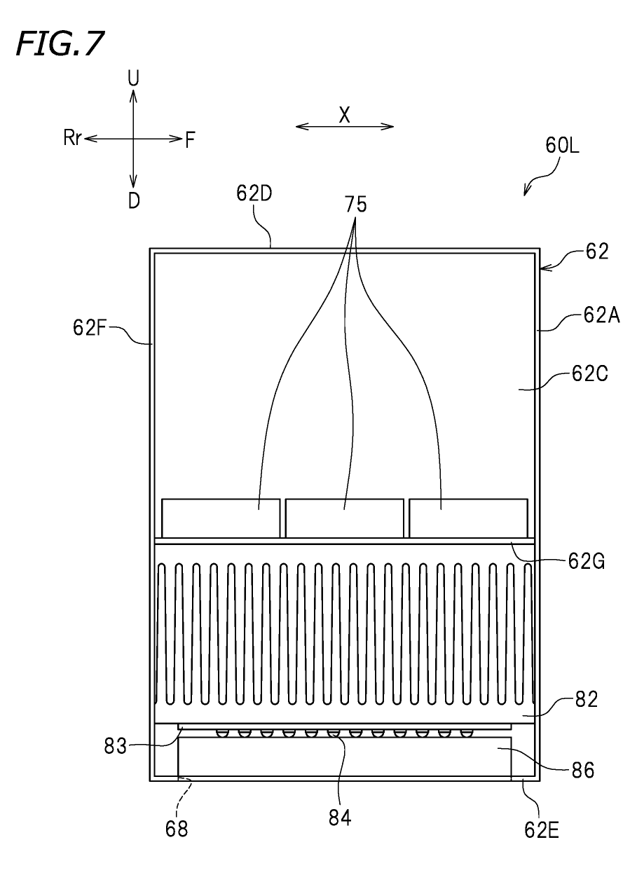

As illustrated in FIG. 6, the fans 75 are disposed in the case 62. The fans 75 are disposed below the inlets 65. The fans 75 are disposed above the outlet 70. The fans 75 are disposed on a support wall 62G extending from the second side wall 62C to the first side wall 62B. The support wall 62G is provided with an opening (not illustrated). The outside air introduced into the inner space 62X through the inlets 65 flows to the heat sink 82 through the fans 75. The air introduced into the inner space 62X through the inlets 65 (i.e., the outside air sucked into the inner space 62X through the inlets 65) flows to the outlet 70 through the heat sink 82 as indicated by the arrows Z in FIG. 6. As illustrated in FIG. 7, the number of fans 75 is three in the present preferred embodiment. The number of fans 75, however, is not limited to any particular number. FIG. 7 is a side view of the left ultraviolet light emitter 60L, with the first side wall 62B removed therefrom.

As illustrated in FIG. 6, the heat sink 82 is disposed in the case 62. The heat sink 82 is disposed below the fans 75. The heat sink 82 is supported by the front wall 62A, the first side wall 62B, the second side wall 62C, and the rear wall 62F. Heat generated by the LEDs 84 is transmitted to the heat sink 82 through an LED substrate 83 (which will be described below).

As illustrated in FIG. 6, the lower wall 62E of the case 62 is provided with an opening 68 extending through the lower wall 62E in the up-down direction. The opening 68 is defined in the lower wall 62E such that the opening 68 faces the platen 16. The opening 68 is located below the outlet 70. As illustrated in FIG. 4, the opening 68 has a rectangular shape. A center C4 of the opening 68 in the main scanning direction Y is located leftward of a center C2 of the case 62 in the main scanning direction Y (see FIG. 6). In other words, the center C4 is located farther away from the ink head 40A than the center C2.

In the present preferred embodiment, each LED 84 is a light-emitting diode (LED) that is able to emit ultraviolet light. Each LED 84 is an example of a light source. The light source may be any type of light source that is able to emit ultraviolet light. Each LED 84 emits ultraviolet light toward the recording medium 5 on the platen 16 through the opening 68. As illustrated in FIG. 6, each LED 84 is disposed in the case 62. Each LED 84 is mounted on the LED substrate 83. The LED substrate 83 is attached to the lower surface of the heat sink 82. Each LED 84 is secured to the heat sink 82 through the LED substrate 83. As illustrated in FIG. 4, the LEDs 84 are arranged in a 2-by-12 matrix with two rows in the main scanning direction Y and twelve columns in the sub-scanning direction X. Alternatively, the LEDs 84 may be arranged in any other suitable manner. The number of LEDs 84 is not limited to any particular number. In the plan view, the LEDs 84 are disposed to overlap with the opening 68. The LEDs 84 include foremost LEDs 84X and rearmost LEDs 84Y. The foremost LEDs 84X are located forward of the foremost ones of the nozzles 41 of the ink head 40A. The rearmost LEDs 84Y are located rearward of the rearmost ones of the nozzles 41 of the ink head 40A.

Through the glass block 86, the ultraviolet light emitted from the LEDs 84 is guided to the opening 68. The ultraviolet light emitted from the LEDs 84 is refracted inside the glass block 86 and extends through the glass block 86. The glass block 86 is an example of a first light guide. The glass block 86 has a cuboid shape. In one example, the glass block 86 is made of quartz glass. As illustrated in FIG. 6, the glass block 86 is disposed in the case 62. The glass block 86 is disposed below the LEDs 84. The glass block 86 is at least partially disposed above the opening 68. As illustrated in FIG. 4, the glass block 86 overlaps with an entirety of the opening 68 in the up-down direction. The glass block 86 covers the entirety of the opening 68. In other words, the glass block 86 may be larger than the opening 68. As illustrated in FIG. 7, the glass block 86 is disposed such that the glass block 86 comes into contact with the LEDs 84 in an expanded state. With the LEDs 84 in a non-expanded state, the glass block 86 is not in contact with the LEDs 84. In one example, the LEDs 84 are in the non-expanded state when the LEDs 84 are at room temperatures (e.g., at about 20° C. to about 25° C.). In other words, with the LEDs 84 in the non-expanded state, a space is defined between the glass block 86 and the LEDs 84. The LEDs 84 expand when the LEDs 84 themselves are heated by emitting ultraviolet light therefrom. The relative positions of the glass block 86 and the LEDs 84 are adjusted in advance such that contact pressure between the glass block 86 and the LEDs 84 will not break the LED(s) 84 that has/have reached a maximum temperature within a usable temperature range. A center C1 of the glass block 86 in the main scanning direction Y is located leftward of the center C2 of the case 62 in the main scanning direction Y (see FIG. 6). In other words, the center C1 is located farther away from the ink head 40A than the center C2.

A center C3 of the LEDs 84 in the main scanning direction Y is located rightward of the center C1 of the glass block 86 in the main scanning direction Y. In other words, the center C3 is located closer to the ink head 40A than the center C1. In the present preferred embodiment, the LEDs 84 are located rightward of the center C1 of the glass block 86 in the main scanning direction Y. In other words, all of the LEDs 84 are located closer to the ink head 40A than the center C1. When the LEDs 84 are arranged in the main scanning direction Y, the term “center C3 of the LEDs 84 in the main scanning direction Y” refers to the center of the LEDs 84 arranged in the main scanning direction Y. In the present preferred embodiment, the LEDs 84 are arranged in two rows in the main scanning direction Y. The center C3 is thus located between the LEDs 84 aligned in one row and the LEDs 84 aligned in the other row. In the present preferred embodiment, the center C2 of the case 62 coincides with the center C3 of the LEDs 84 in the main scanning direction Y. The center C2 and the center C3 may be located at any other suitable positions. Although the center C1 of the glass block 86 coincides with the center C4 of the opening 68 in the main scanning direction Y, the center C1 and the center C4 may be located at any other suitable positions.

The center C3 of the LEDs 84 in the main scanning direction Y is located rightward of the center C4 of the opening 68 in the main scanning direction Y. In other words, the center C3 is located closer to the ink head 40A than the center C4. In the present preferred embodiment, the LEDs 84 are located rightward of the center C4 of the opening 68 in the main scanning direction Y. All of the LEDs 84 are thus located closer to the ink head 40A than the center C4.

As illustrated in FIG. 5, the controller 50 controls printing to be performed on the recording medium 5. The controller 50 is not limited to any particular configuration. In one example, the controller 50 is a microcomputer. Although the microcomputer is not limited to any particular hardware configuration, the microcomputer includes, for example, an interface (I/F), a central processing unit (CPU), a read-only memory (ROM), a random-access memory (RAM), and a storage. As illustrated in FIG. 1, the controller 50 is provided inside the printer body 10a. The controller 50 does not necessarily have to be provided inside the printer body 10a. Alternatively, the controller 50 may be, for example, a computer external to the printer body 10a. In this case, the controller 50 is connected to the printer body 10a so as to enable wire or wireless communication between the controller 50 and the printer 10.

As illustrated in FIG. 5, the controller 50 is communicably connected to the operation panel 12, the carriage motor 24 of the head conveyor 31, the feed motor 27 of the medium conveyor 32, the ink heads 40A to 40D, the fans 75, and the LEDs 84. The controller 50 controls the operation panel 12, the carriage motor 24, the feed motor 27, the ink heads 40A to 40D, the left ultraviolet light emitter 60L, and the right ultraviolet light emitter 60R.

As illustrated in FIG. 5, the controller 50 controls driving of the carriage motor 24 so as to control rotation of the pulley 22 and running of the belt 23 (see FIG. 1). The controller 50 thus controls movement of the ink heads 40A to 40D in the main scanning direction Y. The controller 50 controls driving of the feed motor 27 so as to control rotation of the grit rollers 25. The controller 50 thus controls movement of the recording medium 5, placed on the platen 16, in the sub-scanning direction X. The controller 50 controls the timing of ink discharge from the ink heads 40A to 40D and the amount of ink to be discharged. The controller 50 controls the LEDs 84 so as to control emission of ultraviolet light to the ultraviolet-curable ink discharged onto the recording medium 5.

The left ultraviolet light emitter 60L and the right ultraviolet light emitter 60R emit ultraviolet light to the ultraviolet-curable ink discharged onto the recording medium 5. When the carriage 30 moves in the onward direction Y1 so as to perform printing, the right ultraviolet light emitter 60R emits ultraviolet light but the left ultraviolet light emitter 60L emits no ultraviolet light. When the carriage 30 moves in the backward direction Y2 so as to perform printing, the left ultraviolet light emitter 60L emits ultraviolet light but the right ultraviolet light emitter 60R emits no ultraviolet light. When the carriage 30 moves in the onward direction Y1 and the backward direction Y2, both of the left ultraviolet light emitter 60L and the right ultraviolet light emitter 60R may emit ultraviolet light.

As described above, the printer 10 according to the present preferred embodiment includes the LEDs 84 to emit ultraviolet light, and the glass block 86 disposed in the case 62. The center C3 of the LEDs 84 in the main scanning direction Y is located closer to the ink heads 40A to 40D than the center C1 of the glass block 86 in the main scanning direction Y. The LEDs 84 emit ultraviolet light in various directions. The ultraviolet light emitted toward the recording medium 5 and/or the platen 16 through the opening 68 includes ultraviolet light emitted toward the ink heads 40A to 40D. The ultraviolet light emitted toward the ink heads 40A to 40D, however, is reflected inside the glass block 86 before reaching the opening 68. The ultraviolet light emitted toward the ink heads 40A to 40D is thus prevented from being directed to the ink heads 40A to 40D. Consequently, the printer 10 according to the present preferred embodiment is able to reduce the amount of ultraviolet light reflected off the recording medium 5 and/or the platen 16 and directed toward the ink heads 40A to 40D, while appropriately emitting ultraviolet light to the ultraviolet-curable ink discharged onto the recording medium 5.

The printer 10 according to the present preferred embodiment includes the LEDs 84 and the glass block 86 disposed in the case 62. The LEDs 84 are located closer in the main scanning direction Y to the ink heads 40A to 40D than the center C1 of the glass block 86 in the main scanning direction Y. Because an entirety of each LED 84 is located closer to the ink heads 40A to 40D than the center C1 of the glass block 86 in the main scanning direction Y in this manner, the printer 10 according to the present preferred embodiment is able to further reduce the amount of ultraviolet light emitted toward the ink heads 40A to 40D. Consequently, the printer 10 according to the present preferred embodiment is able to further reduce the amount of ultraviolet light reflected off the recording medium 5 and/or the platen 16 and directed toward the nozzles 41 of the ink heads 40A to 40D.

The printer 10 according to the present preferred embodiment includes the glass block 86 disposed in the case 62. The center C1 of the glass block 86 in the main scanning direction Y is located farther away from the ink heads 40A to 40D than the center C2 of the case 62 in the main scanning direction Y. Because the glass block 86 is located farther away from the ink heads 40A to 40D in this manner, the printer 10 according to the present preferred embodiment is able to further reduce the amount of ultraviolet light emitted toward the ink heads 40A to 40D. An optical path for the ultraviolet light emitted toward the ink heads 40A to 40D is long, so that the intensity of the ultraviolet light emitted toward the ink heads 40A to 40D decreases accordingly. Consequently, the ultraviolet-curable ink attached to the nozzles 41, for example, is unlikely to be cured by the ultraviolet light reflected off the recording medium 5 and/or the platen 16 and directed to the ink heads 40A to 40D.

The glass block 86 of the printer 10 according to the present preferred embodiment is made of quartz glass and overlaps with the entirety of the opening 68 of the case 62 in the up-down direction. The ultraviolet light emitted from the LEDs 84 is thus directed to the ultraviolet-curable ink, discharged onto the recording medium 5, through the opening 68 with higher efficiency.

The glass block 86 of the printer 10 according to the present preferred embodiment is disposed such that the glass block 86 comes into contact with the LEDs 84 in the expanded state. The ultraviolet light emitted from the LEDs 84 is thus directed to the ultraviolet-curable ink, discharged onto the recording medium 5, through the opening 68 of the case 62 with higher efficiency.

The printer 10 according to the present preferred embodiment includes the LEDs 84 and the opening 68 defined in the case 62. The center C3 of the LEDs 84 in the main scanning direction Y is located closer to the ink heads 40A to 40D than the center C4 of the opening 68 in the main scanning direction Y. Consequently, the printer 10 according to the present preferred embodiment is able to reduce the amount of ultraviolet light emitted toward the ink heads 40A to 40D while appropriately emitting ultraviolet light to the ultraviolet-curable ink discharged onto the recording medium 5.

The printer 10 according to the present preferred embodiment includes the LEDs 84 and the opening 68 defined in the case 62. The LEDs 84 are located closer in the main scanning direction Y to the ink heads 40A to 40D than the center C4 of the opening 68 in the main scanning direction Y. Because the entirety of each LED 84 is located closer to the ink heads 40A to 40D than the center C4 of the opening 68 in the main scanning direction Y in this manner, the printer 10 according to the present preferred embodiment is able to further reduce the amount of ultraviolet light emitted toward the ink heads 40A to 40D. Consequently, the printer 10 according to the present preferred embodiment is able to further reduce the amount of ultraviolet light reflected toward the nozzles 41 of the ink heads 40A to 40D.

The printer 10 according to the present preferred embodiment includes the opening 68 defined in the case 62. The center C4 of the opening 68 in the main scanning direction Y is located farther away from the ink heads 40A to 40D than the center C2 of the case 62 in the main scanning direction Y. Because the opening 68 is located farther away from the ink heads 40A to 40D in this manner, the printer 10 according to the present preferred embodiment is able to further reduce the amount of ultraviolet light emitted toward the ink heads 40A to 40D. The optical path for the ultraviolet light emitted toward the ink heads 40A to 40D is long, so that the intensity of the ultraviolet light emitted toward the ink heads 40A to 40D decreases accordingly. Consequently, the ultraviolet-curable ink attached to the nozzles 41, for example, is unlikely to be cured by the ultraviolet light reflected off the recording medium 5 and/or the platen 16 and directed to the ink heads 40A to 40D.

### Second Preferred Embodiment

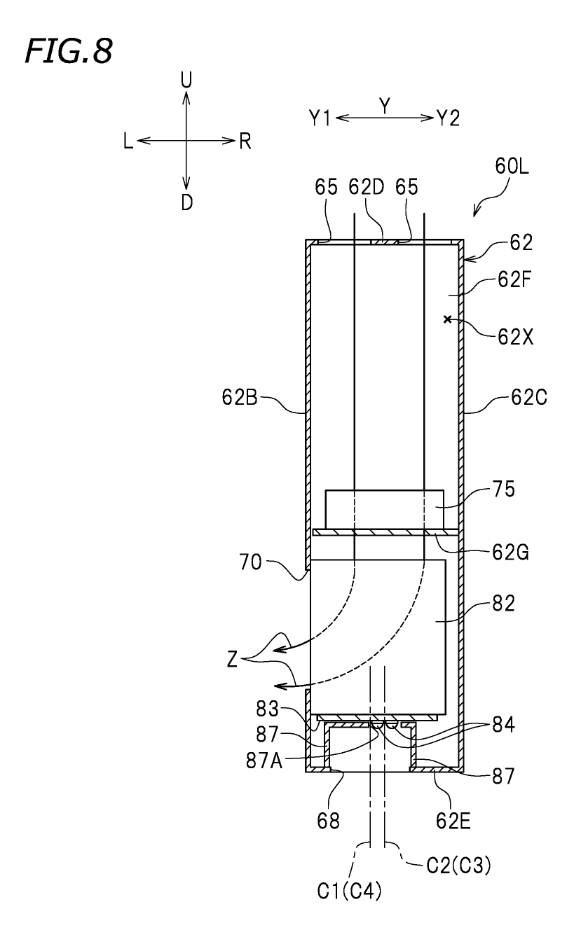

FIG. 8 is a cross-sectional view of the left ultraviolet light emitter 60L according to a second preferred embodiment of the present invention. The left ultraviolet light emitter 60L according to the second preferred embodiment includes a frame 87 made of a metallic material instead of the glass block 86. The frame 87 guides the ultraviolet light, emitted from the LEDs 84, to the opening 68. The frame 87 is an example of the first light guide. The frame 87 reflects the ultraviolet light emitted from the LEDs 84. The frame 87 may be made of any metallic material that is able to reflect ultraviolet light. Examples of such a metallic material include aluminum. The frame 87 is disposed in the case 62. The frame 87 is at least partially disposed below the LEDs 84. The frame 87 is disposed above the opening 68. The frame 87 is disposed around the opening 68. The frame 87 is disposed to cover the entirety of the opening 68. The frame 87 is provided with an opening 87A. The ultraviolet light emitted from the LEDs 84 extends through the opening 87A.

The frame 87 of the printer 10 according to the second preferred embodiment is disposed around the opening 68 defined in the case 62. The ultraviolet light emitted from the LEDs 84 is thus directed to the ultraviolet-curable ink, discharged onto the recording medium 5, through the opening 68 with higher efficiency.

In the second preferred embodiment, the frame 87 is made of a metallic material that is able to reflect ultraviolet light. Alternatively, the frame 87 may be made of any other suitable material. In one example, the frame 87 may be or may include a mirror. In another example, a mirror may be additionally provided on the inner surface of the frame 87 (i.e., a surface of the frame 87 to which ultraviolet light may be emitted).

In still another example, the frame 87 may be an absorber to absorb ultraviolet light emitted from the LEDs 84. When no absorber is provided, ultraviolet light that directly reaches the opening 68 from the LEDs 84 may be widely scattered through the opening 68 and is thus likely to be directed toward the ink heads 40A to 40D. Absorbing the ultraviolet light by the absorber makes it possible to reduce the amount of ultraviolet light directed toward the ink heads 40A to 40D.

### Third Preferred Embodiment

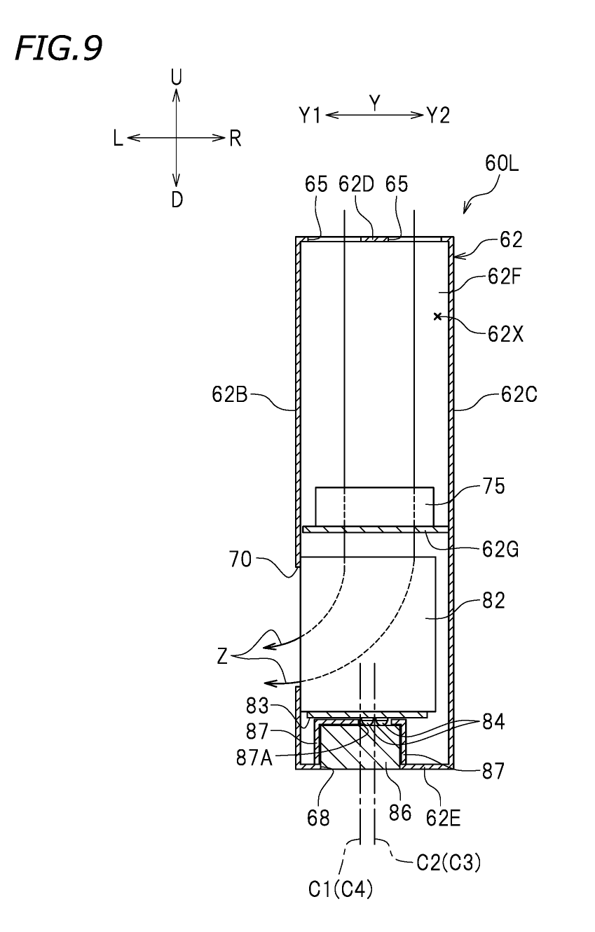

FIG. 9 is a cross-sectional view of the left ultraviolet light emitter 60L according to a third preferred embodiment of the present invention. The left ultraviolet light emitter 60L according to the third preferred embodiment includes the frame 87 made of a metallic material in addition to the glass block 86. The frame 87 is disposed around the glass block 86. The glass block 86 is disposed inward of the frame 87. In the third preferred embodiment, the glass block 86 is an example of the first light guide, and the frame 87 is an example of a second light guide.

The printer 10 according to the third preferred embodiment includes the left ultraviolet light emitter 60L and the right ultraviolet light emitter 60R each including the frame 87. The frame 87 is at least partially disposed below the LEDs 84. The frame 87 is disposed above the opening 68 defined in the case 62. The frame 87 is disposed around the glass block 86. The frame 87 guides the ultraviolet light, emitted from the LEDs 84, to the opening 68. The ultraviolet light emitted from the LEDs 84 is thus directed to the ultraviolet-curable ink, discharged onto the recording medium 5, through the opening 68 with higher efficiency.

Although the preferred embodiments of the present invention have been described thus far, the preferred embodiments described above are only illustrative. The present invention may be embodied in various other forms.

In each of the foregoing preferred embodiments, the printer 10 is configured such that the carriage 30 moves in the main scanning direction Y and the recording medium 5 placed on the platen 16 moves in the sub-scanning direction X, for example. The printer 10, however, is not limited to this configuration. Because the printer 10 is required to move the carriage 30 and the recording medium 5 relative to each other, either one of the carriage 30 and the recording medium 5 may move in the main scanning direction Y or the sub-scanning direction X. In one example, the printer 10 may be configured such that the recording medium 5 is immovably placed on the platen 16 and the carriage 30 is movable in both of the main scanning direction Y and the sub-scanning direction X. In another example, the printer 10 may be configured such that both of the carriage 30 and the recording medium 5 are movable in both of the main scanning direction Y and the sub-scanning direction X.

The techniques disclosed herein are applicable to various types of printers. The techniques disclosed herein are applicable to not only a “roll-to-roll” printer that moves the recording medium 5 in a roll form illustrated in the foregoing preferred embodiments but also a flatbed inkjet printer, for example. When the techniques disclosed herein are applied to a flatbed inkjet printer, a table on which the recording medium 5 is placed moves in the sub-scanning direction X and the up-down direction.

In each of the foregoing preferred embodiments, the outlet 70 is located below the inlets 65, for example. Alternatively, the outlet 70 and the inlets 65 may each be located at any other suitable location. In one example, the outlet 70 may be located in the upper wall 62D of the case 62, and the inlets 65 may be located in the first side wall 62B of the case 62. In other words, the outlet 70 may be located above the inlets 65. In this case, the fans 75 are disposed above the inlets 65 and below the outlet 70 such that outside air introduced into the inner space 62X from below the fans 75 flows upward to the outlet 70 through the fans 75.

In each of the foregoing preferred embodiments, the glass block 86 made of quartz glass is used as an example of the first light guide. Alternatively, the glass block 86 may be made of any other suitable material. In one example, the first light guide may be made of a resin material such that ultraviolet light emitted from the LEDs 84 is refracted and extend through the first light guide.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inkjet printer comprising:
a table on which a recording medium is to be placed;
a carriage disposed above the table and movable in a main scanning direction;
an ink head mounted on the carriage and including a nozzle to discharge ultraviolet-curable ink onto the recording medium placed on the table; and
an ultraviolet light emitter mounted on the carriage and disposed on one side relative to the ink head in the main scanning direction to emit ultraviolet light to the ultraviolet-curable ink discharged onto the recording medium; wherein
the ultraviolet light emitter includes:
a case including an opening in a portion of the case that faces the table;
a light source located in the case to emit ultraviolet light toward the recording medium on the table through the opening; and
a first light guide at least partially disposed below the light source and above the opening to guide the ultraviolet light emitted from the light source to the opening; and
a center of the light source in the main scanning direction is located closer to the ink head than a center of the first light guide in the main scanning direction.

2. The inkjet printer according to claim 1, wherein the light source is located closer in the main scanning direction to the ink head than the center of the first light guide in the main scanning direction.

3. The inkjet printer according to claim 1, wherein the center of the first light guide in the main scanning direction is located farther away from the ink head than a center of the case in the main scanning direction.

4. The inkjet printer according to claim 1, wherein
the first light guide has a cuboid shape; and
the first light guide allows the ultraviolet light emitted from the light source to be refracted and pass through the first light guide.

5. The inkjet printer according to claim 4, wherein
the first light guide is made of quartz glass; and
the first light guide overlaps with an entirety of the opening in an up-down direction.

6. The inkjet printer according to claim 4, wherein
the first light guide is made of a resin material; and
the first light guide overlaps with an entirety of the opening in an up-down direction.

7. The inkjet printer according to claim 4, wherein the first light guide is disposed to come into contact with the light source in an expanded state.

8. The inkjet printer according to claim 1, wherein
the first light guide is an absorber to absorb the ultraviolet light emitted from the light source; and
the first light guide is disposed around the opening.

9. The inkjet printer according to claim 1, wherein
the first light guide is a metallic material or a mirror that reflects the ultraviolet light emitted from the light source; and
the first light guide is disposed around the opening.

10. The inkjet printer according to claim 4, wherein
the ultraviolet light emitter includes a second light guide at least partially disposed below the light source, disposed above the opening, and disposed around the first light guide;
the second light guide guides the ultraviolet light emitted from the light source to the opening.

11. The inkjet printer according to claim 1, wherein the center of the light source in the main scanning direction is located closer to the ink head than a center of the opening in the main scanning direction.

12. The inkjet printer according to claim 11, wherein the light source is located closer in the main scanning direction to the ink head than the center of the opening in the main scanning direction.

13. The inkjet printer according to claim 11, wherein the center of the opening in the main scanning direction is located farther away from the ink head than a center of the case in the main scanning direction.
